(19) United States
(12) Patent Application Publication
(10) Pub. No.: US 2008/0154010 A1
(43) Pub. Date: Jun. 26, 2008

(54) Anodic electrodeposition coating composition

(76) Inventors: Gabriele Buettner, Ratingen (DE); Andreas Fieberg, Dusseldorf (DE); Carmen Flosbach, Wuppertal (DE); Thomas Grawe, Leverkusen (DE); Tanja Renkes, Essen (DE)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/002,974

(22) Filed: Dec. 19, 2007

Related U.S. Application Data
(60) Provisional application No. 60/876,671, filed on Dec. 22, 2006.

(51) Int. Cl. C08G 67/00; C08G 18/00

(52) U.S. Cl. 528/48; 528/45; 528/425

(57) ABSTRACT

An AED coating composition comprising, apart from water,
(A) 1 to 20, relative to the resin solids content of the composition, of at least one resin with functional groups selected from the group consisting of hydroxyl groups, free isocyanate groups and blocked isocyanate groups, the resin is present as particles with melting temperatures from 40 to 200° C.,
(B) at least one film-forming, self- or externally cross-linking AED binder different from resin (A), and
(C) optionally, at least one component selected from the group consisting of cross-linking agents, paste resins, grinding resins, nonionic resins, fillers, pigments, fillers, extenders, coating additives and organic solvents;
the AED coating compositions have a distinctly reduced or no edge migration behavior upon deposition and baking.

### CROSS REFERENCE TO RELATED APPLICATIONS

This application claims the benefit of U.S. Provisional Application Ser. No. 60/876,671 filed on Dec. 22, 2006 which is hereby incorporated by reference.

### FIELD OF THE INVENTION

The invention relates to an anodic electro-deposition (AED) coating composition providing improved edge protection.

### BACKGROUND OF THE INVENTION

Electro-deposition of AED coating compositions is a fully automated, environmentally friendly and economic application method and is therefore used in practice in the mass production lacquering of electrically conducting surfaces, in particular, metal surfaces. For example, AED coating compositions are used in particular to produce anti-corrosive primer layers on metal substrates. They may also be anodically deposited and baked as, for example, a single-layer top coat, clear coat or as a coating layer which is arranged within a multilayer coating. An AED coating layer arranged within a multilayer coating may, for example, be a coating layer with decorative effect which acts as a top coat or to which a clear coat layer may further be applied.

When an AED coating layer previously deposited onto an electrically conductive substrate is baked an edge migration can arise. The AED coating film pulls away from the edge, reducing the film thickness at and/or in the immediate vicinity of the edge. Under extreme circumstances, the edge is not coated after baking, and this results in the substrate showing through in the region of the edge and in a loss of corrosion protection. AED coating compositions thus often contain additives which enhance edge coverage or edge corrosion protection.

On the other hand, AED coating compositions with good edge coverage and thus good edge corrosion protection are generally distinguished in that the optical surface quality of coating layers produced therefrom is in need of improvement, i.e., the AED-coated surfaces are relatively rough. Conversely, AED coating compositions from which coatings with good optical surface quality may be produced often exhibit edge coverage which is in need of improvement. Therefore, the properties often require compromises to be made when selecting an AED coating composition.

Therefore, there is a need to provide an AED coating composition which exhibits slight or no edge migration behavior on baking of the coating layers anodically deposited therefrom. The AED coatings applied from the AED coating composition should simultaneously have good optical surface quality.

### SUMMARY OF THE INVENTION

The invention is directed to an AED coating composition comprising, apart from water,
(A) 1 to 20, preferably 5 to 15 wt. %, relative to the resin solids content of the composition, of at least one resin with functional groups selected from the group consisting of hydroxyl groups, free isocyanate groups and blocked isocyanate groups, the resin is present as particles with melting temperatures from 40 to 200° C., in particular from 60 to 180° C.,
(B) at least one film-forming, self- or externally cross-linking AED binder different from resin (A), and
(C) optionally, at least one component selected from the group consisting of cross-linkers (cross-linking agents), paste resins (grinding resins), nonionic resins, pigments, fillers (extenders), coating additives and organic solvents.

The AED coating compositions according to the invention are distinguished by a distinctly reduced edge migration behavior or even no edge migration when the AED coating films deposited from them are baked. The optical surface quality of the baked AED coating films is good, i.e., the AED coating film surface exhibits a low roughness, and the AED coating compositions are more resistant towards crater formation within the AED coating films anodically deposited from them compared to corresponding AED coating compositions free of the at least one resin (A).

### DETAILED DESCRIPTION OF THE EMBODIMENTS

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

Slight variations above and below the stated ranges specified in this application can be used to achieve substantially the same results as values within the ranges. Also, the disclosure of these ranges is intended as a continuous range including every value between the minimum and maximum values.

The AED coating composition according to the invention is an aqueous coating composition with a solids content of, for example, 10 to 30 wt. %. The solids content consists of the resin solids content, the content of the at least one resin (A) and of the following optional components: fillers, pigments and/or other non-volatile coating additives. The at least one resin (A) does not count as a constituent of the resin solids content. The resin solids content itself consists of the AED binder (B), optionally present paste resins, optionally present cross-linkers and optionally present nonionic resins. All the constituents belonging to the resin solids content are either liquid and/or soluble in organic solvents. Paste resins are classed among the AED binder (B).

The AED binder (B) has anionic substituents and/or substituents which can be converted into anionic groups. The AED binder may be self-cross-linking or preferably, externally cross-linking, in the latter case it has groups capable of chemical cross-linking and the AED coating composition then contains cross-linkers. The cross-linkers may also have anionic groups.

For example, the resin solids composition of the AED coating composition according to the invention comprising 50 to 100 wt % of AED binder (B), 0 to 40 wt % of cross-linkers, and 0 to 10 wt % of nonionic resins. The resin solids composition of the AED coating composition comprising preferably 50 to 90 wt % of externally cross-linking AED binder (B), 10 to 40 wt % of cross-linkers, and 0 to 10 wt % of nonionic resins.

The anionic groups may be, for example, carboxylic, sulfonic and/or phosphonic groups, or the substituents may be converted into anionic groups with bases, such as, e.g., sodium hydroxide, potassium hydroxide, lithium hydroxide; primary or tertiary amines, such as, e.g., diethyl amines, triethyl amines, morpholin, alkanole amines, such as, e.g., dimethyl amino ethanol; quarternary ammonium hydroxides or polyamines, e.g., ethylene diamine, diethylene triamine and triethylene tetramine.

The AED binder (B) are preferably resins containing carboxylic, sulfonic and/or phosphonic groups. The weight average molar mass of the AED binder (B) is preferably 300 to 10,000. As self-cross-linking or preferably externally cross-linking binders, the AED binders bear functional groups capable of chemical cross-linking, particularly hydroxyl groups, and have a hydroxyl value of, for example, 30 to 300, preferably 50 to 250 mg KOH/g.

Examples of AED binder (B) are, for example, polyesters, poly (meth)acrylates, polybutadien oils, maleic oils.

The term “(meth)acryl” used in the present description and the claims means acryl and/or methacryl.

Examples of cross-linkers include aminoplastic resins (amine/formaldehyd resins), cross-linkers having terminal double bonds, cross-linkers having cyclic carbonate groups, polyepoxy compounds, cross-linkers containing groups capable of transesterification and/or transamidisation, and particularly polyisocyanates that are blocked with conventional blocking agents, such as, for example, monoalcohols, glycol ethers, ketoximes, lactams, malonic acid esters, acetoacetic acid esters, pyrazole.

All the number or weight average molar mass data stated in the present description are determined or to be determined by gel permeation chromatography (GPC; divinylbenzene-cross-linked polystyrene as the immobile phase, tetrahydrofuran as the liquid phase, polystyrene standards).

To produce the AED coating compositions the anionic binder (B) may be used as AED binder dispersion which may be produced by synthesis of AED binder (B) in the presence or absence of organic solvents and conversion into an aqueous dispersion by diluting the neutralized AED binder with water. The AED binder (B) may be present in a mixture with one or more non-ionic resins and/or one or more suitable cross-linkers and/or the at least one resin (A) and be converted into the aqueous dispersion together with them. If present, organic solvent may be removed down to the desired content, for example, by distillation before or after conversion into the aqueous dispersion. Subsequent removal of solvents may be avoided, for example, if the AED binder (B) are neutralized in the low-solvent or solvent-less state, for example, as solvent-less melt, for example, at temperatures of up to 140° C. and then converted into the AED binder dispersion with water.

The AED coating compositions may contain non-ionic resins. Examples of non-ionic resins are (meth)acrylic copolymer resins, polyester resins and polyurethane resins. The non-ionic resins preferably have functional groups, particularly cross-linkable functional groups. Preferably they are the same cross-linkable functional groups as the AED binder (B) contains. Preferred examples of such functional groups are hydroxyl groups.

The AED coating composition according to the invention contains, relative to the resin solids content thereof, 1 to 20, preferably 5 to 15 wt % of the at least one resin (A) with functional groups selected from the group consisting of hydroxyl groups, free isocyanate groups and blocked isocyanate groups. The resin (A) comprises resins which are present as particles and exhibit a melting temperature of 40 to 200° C., in particular of 60 to 180° C. The melting temperatures are not in general sharp melting points, but instead the upper end of melting ranges with a breadth of, for example, 30 to 150° C. The melting ranges and thus, the melting temperatures may be determined, for example, by DSC (differential scanning calorimetry) at heating rates of 10 K/min.

The resin (A) may be present in the AED coating composition in particular in a mixture with the AED binder (B) as a dispersion as described above. The resin (A) is very slightly, if at all, soluble in organic solvents conventional used in coatings and/or in water, the solubility amounting, for example, to less than 10, in particular less than 5 g per litre of butyl acetate or water at 20° C.

Resins (A) with hydroxyl groups, free isocyanate groups and/or blocked isocyanate groups are preferred. It is advantageous and preferred if the resin (A) can be involved in the chemical cross-linking process with their hydroxyl or free isocyanate or blocked isocyanate groups during thermal curing of the coating layers anodically deposited from those AED coating compositions having an AED binder/cross-linker system.

In particular, the resins (A) are polyurethane resins with functional groups selected from the group consisting of hydroxyl groups, free isocyanate groups and blocked isocyanate groups.

The production of polyurethane resins (A) is known to the person skilled in the art; in particular, they may be produced by reacting polyol(s) with polyisocyanate(s) and, in case of isocyanate excess, reacting the excess free isocyanate groups with blocking agent(s). Polyols suitable for the production of the polyurethane resins (A) are not only polyols in the form of low molar mass compounds defined by empirical and structural formula but also oligomeric or polymeric polyols with number-average molar masses of, for example, up to 800, for example, corresponding hydroxyl-functional polyethers, polyesters or polycarbonates; low molar mass polyols defined by an empirical and structural formula are, however, preferred. The person skilled in the art selects the nature and proportion of the polyisocyanates, the polyols and the possible blocking agents for the production of polyurethane resins (A) in such a manner that polyurethane resins (A) with the above-mentioned melting temperatures and the above-mentioned solubility behavior are obtained.

The polyurethane resins (A) may be produced in the presence of a suitable organic solvent (mixture), which, however, makes it necessary to isolate the polyurethane resins (A) obtained in this manner or remove the solvent therefrom. Preferably, the production of the polyurethane resins (A) is, however, carried out without solvent and without subsequent purification operations.

In a first embodiment the polyurethane resins (A) are hydroxyl-functional polyurethane resins. They may be produced, for example, by reacting polyisocyanate(s) with polyol(s) in excess. The hydroxyl-functional polyurethane resins (A) have hydroxyl values of, for example, 50 to 300 mg KOH/g.

In a first preferred variant of the first embodiment, the hydroxyl-functional polyurethane resins (A) are polyurethane diols which can be prepared by reacting 1,6-hexane diisocyanate or 4,4′-diphenylmethane diisocyanate stoichiometrically with a diol component in the molar ratio x:(x+1), wherein x means any desired value from 2 to 6, preferably, from 2 to 4. One single diol, in particular, one single diol with a molar mass in the range of 62 to 600 can be used as the diol component. It is also possible to use a combination of diols, preferably two to four, in particular two or three diols, wherein each of the diols preferably constitutes at least 10 mol % of the diols of the diol component.

In the case of the diol combination, the diol component may be introduced as a mixture of its constituent diols or the diols constituting the diol component may be introduced individually into the synthesis. It is also possible to introduce a proportion of the diols as a mixture and to introduce the remaining proportion or proportions in the form of pure diol.

Examples of one single diols are bisphenol A and (cyclo)aliphatic diols, such as, ethylene glycol, the isomeric propane- and butanediols, 1,5-pentanediol, 1,6-hexanediol, 1,10-decanediol, 1,12-dodecanediol, 1,4-cyclohexanedimethanol, hydrogenated bisphenol A and dimer fatty alcohol. The term “(cyclo)aliphatic” used in the description and the claims encompasses cycloaliphatic, linear aliphatic, branched aliphatic and cycloaliphatic with aliphatic residues. Diols differing from (cyclo)aliphatic diols, i.e., non-(cyclo)aliphatic diols, accordingly comprise aromatic or araliphatic diols with aromatically and/or aliphatically attached hydroxyl groups.

Examples of diols which are possible as constituents of the diol component are oligomeric or polymeric diols, such as, telechelic (meth)acrylic polymer diols, polyester diols, polyether diols, polycarbonate diols, each with a number-average molar mass of, for example, up to 800; low molar mass non-(cyclo)aliphatic diols defined by empirical and structural formula, such as, bisphenol A; (cyclo)aliphatic diols defined by empirical and structural formula with a low molar mass in the range of 62 to 600, such as, ethylene glycol, the isomeric propane- and butanediols, 1,5-pentanediol, 1,6-hexanediol, 1,10-decanediol, 1,12-dodecanediol, neopentyl glycol, butylethylpropanediol, the isomeric cyclohexanediols, the isomeric cyclohexanedimethanols, hydrogenated bisphenol A, tricyclodecanedimethanol, and dimer fatty alcohol.

The diisocyanate and the diol component are preferably reacted together in the absence of solvents. The reactants may here all be reacted together simultaneously or in two or more synthesis stages. When the synthesis is performed in multiple stages, the reactants may be added in the most varied order, for example, also in succession or in alternating manner. The diol component may, for example, be divided into two or more portions or into the individual diols, for example, such that the diisocyanate is initially reacted with part of the diol component before further reaction with the remaining proportion of the diol component. The individual reactants may in each case be added in their entirety or in two or more portions. The reaction is exothermic and proceeds at a temperature above the melting temperature of the reaction mixture. The reaction temperature is, for example, 60 to 200 C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvent is complete and the reaction mixture has cooled, solid polyurethane diols are obtained. When low molar mass diols defined by empirical and structural formula are used for synthesis of the polyurethane diols, their calculated molar masses are in the range of 522 or above, for example, up to 2200.

The resulted polyurethane diols may be used directly as hydroxyl-functional polyurethane resins (A).

In a second preferred variant of the first embodiment, the hydroxyl-functional polyurethane resins (A) are polyurethane diols which can be prepared by reacting stoichiometrically a diisocyanate component and bisphenol A or a diol component in the molar ratio x:(x+1), wherein x means any desired value from 2 to 6, preferably, from 2 to 4, wherein 50 to 80 mol % of the diisocyanate component is formed by 1,6-hexane diisocyanate, and 20 to 50 mol % by one or two diisocyanates, each forming at least 10 mol % of the diisocyanate component and being selected from the group consisting of toluylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein the mol % of the respective diisocyanates add up to 100 mol %, wherein 20 to 100 mol % of the diol component is formed by at least one linear aliphatic alpha,omega-C2-C12-diol, and 0 to 80 mol % by at least one diol that is different from linear aliphatic alpha,omega-C2-C12-diols, wherein each diol of the diol component preferably forms at least 10 mol % within the diol component, and wherein the mol % of the respective diols add up to 100 mol %.

Preferably, the diisocyanate or the two diisocyanates, forming in total 20 to 50 mol % of the diisocyanate component, are selected from dicyclohexylmethane diisocyanate, isophorone diisocyanate, trimethylhexane diisocyanate, cyclohexane diisocyanate, cyclohexanedimethylene diisocyanate and tetramethylenexylylene diisocyanate.

The diol component preferably consists of no more than four different diols, in particular only of one to three diols. In the case of only one diol, it accordingly comprises a linear aliphatic alpha,omega-C2-C12-diol. In the case of a combination of two, three or four diols, the diol component consists preferably to an extent of 80 to 100 mol %, of at least one linear aliphatic alpha,omega-C2-C12-diol and to an extent of 0 to 20 mol % of at least one diol differing from linear aliphatic alpha,omega-C2-C12-diols and preferably, also from alpha,omega-diols with more than 12 carbon atoms. The at least one diol differing from linear aliphatic alpha,omega-C2-C12-diols and preferably, also from alpha,omega-diols with more than 12 carbon atoms comprises in particular diols defined by empirical and structural formula and with a low molar mass in the range of 76 to 600.

Preferably, the diol component consists of one to four, preferably, one to three, and in particular only one linear aliphatic alpha,omega-C2-C12-diol.

In the case of the diol combination, the diol component may be introduced as a mixture as described above.

Examples of linear aliphatic alpha,omega-C2-C12-diols that may be used as one single diol of the diol component or as constituents of the diol component are ethylene glycol, 1,3-propanediol, 1,4-butanediol, 1,5-pentanediol, 1,6-hexanediol, 1,10-decanediol and 1,12-dodecanediol.

Examples of diols that are different from linear aliphatic alpha,omega-C2-C12-diols and may be used in the diol component are oligomeric or polymeric diols as mentioned above; (cyclo)aliphatic diols defined by empirical and structural formula with a low molar mass in the range of 76 to 600, such as, those isomers of propanediol and butanediol that are different from the isomers of propanediol and butanediol specified in the preceding paragraph, as well as, neopentyl glycol, butyl ethyl propanediol, the isomeric cyclohexanediols, the isomeric cyclohexanedimethanols, hydrogenated bisphenol A, tricyclodecanedimethanol, and dimer fatty alcohol.

The diisocyanate component and the bisphenol A or the diol component are preferably reacted together in the absence of solvents as described above. The bisphenol A or the diol component may, for example, be divided into two or more portions or into the individual diols, for example, such that the diisocyanates are initially reacted with part of the bisphenol A or of the diol component before further reaction with the remaining proportion of the bisphenol A or of the diol component. Equally, however, the diisocyanate component may also be divided into two or more portions or into the individual diisocyanates, for example, such that the hydroxyl components are initially reacted with part of the diisocyanate component and finally with the remaining proportion of the diisocyanate component.

The reaction process may further proceed as already described above resulting in solid polyurethane diols as already described above which may be used directly as hydroxyl-functional polyurethane resins (A).

If, in individual cases, a proportion of the dihydroxy compound(s) used for the synthesis of those polyurethane diols according to the first or second preferred variant of the first embodiment stated above is replaced by a triol component comprising at least one triol, polyurethane resins (A) are obtained which are branched and/or more highly hydroxyl-functional compared to the respective polyurethane diols. Variants with such polyurethane resins (A) are themselves further preferred variants of the first embodiment. For example, up to 70% of the dihydroxy compound(s) in molar terms may be replaced by the triol(s) of the triol component. Examples of triols are trimethylolethane, trimethylolpropane and/or glycerol. Glycerol is preferably used alone as a triol component.

In a second embodiment the polyurethane resins (A) are isocyanate-functional polyurethane resins (A). They may be produced by reacting polyol(s) with polyisocyanate(s) in the excess. The polyurethane resins (A) have isocyanate contents of, for example, 2 to 13.4 wt % (calculated as NCO, molar mass 42).

In a first preferred variant of the second embodiment, the isocyanate-functional polyurethane resins A are polyurethane diisocyanates which can be prepared by reacting stoichiometrically 1,6-hexane diisocyanate or 4,4′-diphenylmethane diisocyanate with a diol component in the molar ratio (x+1):x, wherein x means any desired value from 2 to 6, preferably, from 2 to 4, and the diol component is one single diol or a combination of diols as described above according to the first variant of the first embodiment.

With regard to the nature and use of the diol component and to the diols possible as constituents reference is made to the statements made in relation to the first preferred variant of the first embodiment.

The diisocyanate and the diol component are preferably reacted together in the absence of solvents. With regard to the sequence of addition of the reactants and the reaction conditions reference is made to the statements made in relation to the first preferred variant of the first embodiment.

Once the reaction carried out in the absence of solvent is complete and the reaction mixture has cooled, solid polyurethane diisocyanates are obtained. When low molar mass diols defined by empirical and structural formula are used for synthesis of the polyurethane diisocyanates, their calculated molar masses are in the range of 628 or above, for example, up to 2300.

The resulted solid polyurethane diols may be used directly as hydroxyl-functional polyurethane resins (A).

In a second preferred variant of the second embodiment, the isocyanate-functional polyurethane resins (A) are polyurethane diisocyanates which can be prepared by reacting stoichiometrically a diisocyanate component and bisphenol A or a diol component in the molar ratio (x+1):x, wherein x means any desired value from 2 to 6, preferably, from 2 to 4. With regard to the nature and use of the diisocyanate and diol component reference is made to the statements made in relation to the second preferred variant of the first embodiment.

With regard to the nature of the diisocyanate component, the nature and the use of the diol component and to the diols possible as constituents reference is made to the statements made in relation to the second preferred variant of the first embodiment.

The diisocyanates of the diisocyanate component and the bisphenol A or the diol(s) of the diol component are preferably reacted together in the absence of solvents. With regard to the sequence of addition of the reactants and the reaction conditions reference is made to the statements made in relation to the second preferred variant of the first embodiment.

Once the reaction carried out in the absence of solvent is complete and the reaction mixture has cooled, solid polyurethane diisocyanates are obtained. When low molar mass diols defined by empirical and structural formula are used for synthesis of the polyurethane diisocyanates, their calculated molar masses are in the range of 625 or above, for example, up to 2300.

The resulted solid polyurethane diols may be used directly as hydroxyl-functional polyurethane resins (A).

In a third preferred variant of the second embodiment, the isocyanate-functional polyurethane resins (A) are polyurethane polyisocyanates which can be prepared by reacting stoichiometrically a trimer of a (cyclo)aliphatic diisocyanate, 1,6-hexane diisocyanate and bisphenol A or a diol component in the molar ratio 1:x:x, wherein x means any desired value from 1 to 6 , preferably, from 1 to 3, wherein the diol component is one single linear aliphatic alpha,omega-C2-C12-diol or a combination of two to four, preferably, two or three, diols, wherein in the case of a diol combination, each of the diols makes up at least 10 mol % of the diols of the diol combination and the diol combination consists of at least 80 mol % of bisphenol A or of at least one linear aliphatic alpha,omega-C2-C12-diol.

The trimer of the (cyclo)aliphatic diisocyanate may be polyisocyanates of the isocyanurate type, prepared by trimerization of a (cyclo)aliphatic diisocyanate. Appropriate trimerization products derived, for example, from 1,4-cyclohexanedimethylenediisocyanate, in particular, from isophorone diisocyanate and more particularly, from 1,6-hexane diisocyanate, are suitable. The industrially obtainable isocyanurate polyisocyanates generally contain, in addition to the pure trimer, i.e., the isocyanurate made up of three diisocyanate molecules and comprising three NCO functions, isocyanate-functional secondary products with a relatively high molar mass. Products with the highest possible degree of purity are preferably used. In each case, the trimers of the (cyclo)aliphatic diisocyanates obtainable in industrial quality are regarded as pure trimer irrespective of their content of said isocyanate-functional secondary products with respect to the molar ratio of 1 mol trimer of the (cyclo)aliphatic diisocyanate:x mol 1,6-hexane diisocyanate:x mol diol compound(s).

Examples of one single linear aliphatic alpha,omega-C2-C12-diol or linear aliphatic alpha,omega-C2-C12-diols which can be used within the diol combination are the same linear aliphatic alpha,omega-C2-C12-diols as described under the second preferred variant of the first embodiment.

Examples of (cyclo)aliphatic diols which can be used within the diol combination in addition to the bisphenol A making up at least 80 mol % of the diol combination or the at least one linear aliphatic alpha,omega-C2-C12-diol making up at least 80 mol % of the diol combination are the further isomers of propane and butane diol, different from the isomers of propane and butane diol cited in the preceding paragraph, and neopentylglycol, butylethylpropanediol, the isomeric cyclohexane diols, the isomeric cyclohexanedimethanols, hydrogenated bisphenol A and tricyclodecanedimethanol.

In the case of the diol combination, the diol component may be introduced as a mixture as described above.

In the case of the diol combination, preferred diol combinations totalling 100 mol % in each case are combinations of 10 to 90 mol % 1,3-propanediol with 90 to 10 mol % 1,5-pentanediol, 10 to 90 mol % 1,3-propanediol with 90 to 10 mol % 1,6-hexanediol and 10 to 90 mol % 1,5-pentanediol with 90 to 10 mol % 1,6-hexanediol.

The trimer of the (cyclo)aliphatic diisocyanate, the 1,6-hexane-diisocyanate and the bisphenol A or the diol component are preferably reacted together in the absence of solvents. The reactants may here all be reacted together simultaneously or in two or more synthesis stages. Synthesis procedures in which the bisphenol A or the diol component and the trimer of the (cyclo)aliphatic diisocyanate alone are reacted with one another are preferably avoided.

When the synthesis is performed in multiple stages, the reactants may be added in the most varied order, for example, also in succession or in alternating manner. For example, the 1,6-hexane diisocyanate may be reacted initially with the bisphenol A or with the diol component and then with the trimer of the (cyclo)aliphatic diisocyanate or a mixture of the isocyanate-functional components with the bisphenol A or with the diol component. In the case of a diol combination, the diol component may, for example, also be divided into two or more portions, for example, also into the individual dihydroxy compounds. The individual reactants may in each case be added in their entirety or in two or more portions. The reaction is exothermic and proceeds at a temperature above the melting temperature of the reaction mixture. The reaction temperature is, for example, 60 to 200° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvents is complete and the reaction mixture has cooled, solid polyurethane polyisocyanates with number average molar masses in the range of 1,500 to 4,000 are obtained. The polyurethane polyisocyanates may be used directly as isocyanate-functional polyurethane resins (A).

In a third embodiment the polyurethane resins (A) are polyurethane resins A with blocked isocyanate groups. They may be produced by reacting polyol(s) with polyisocyanate(s) in excess and reacting the excess free isocyanate groups with one or more monofunctional blocking agents. The latent isocyanate content of the polyurethane resins (A) with blocked isocyanate groups is, for example, in the range from 2 to 21.2 wt. %, calculated as NCO and relative to the corresponding underlying polyurethane resins, i.e., which are free of blocking agent(s).

In a first preferred variant of the third embodiment, the polyurethane resins A have two blocked isocyanate groups per molecule and can be prepared by reacting stoichiometrically 1,6-hexane diisocyanate or 4,4′-diphenylmethane diisocyanate with a diol component and with at least one monofunctional blocking agent in the molar ratio x:(x−1):2, wherein x means any desired value from 2 to 6, preferably, from 2 to 4, and the diol component is one single diol or a combination of diols as described above according to the first variant of the first embodiment.

With regard to the nature and use of the diol component and to the diols possible as constituents, in order to avoid repetition, reference is made to the statements made in relation to the first preferred variant of the first embodiment.

Preferably, only one monofunctional blocking agent is used. Examples of the at least one monofunctional blocking agent are the monofunctional compounds known for blocking isocyanate groups, such as, the CH-acidic, NH—, SH— or OH-functional compounds known for this purpose. Examples are CH-acidic compounds, such as, acetylacetone or CH-acidic esters, such as, acetoacetic acid alkyl esters, malonic acid dialkyl-esters; aliphatic or cycloaliphatic alcohols, such as, n-butanol, 2-ethylhexanol, cyclohexanol; glycol ethers, such as, butyl glycol, butyl diglycol; phenols; oximes, such as, methyl ethyl ketoxime, acetone oxime, cyclohexanone oxime; lactams, such as, caprolactam; azole blocking agents of the imidazole, pyrazole, triazole or tetrazole type.

The diisocyanate, the diol component and the at least one monofunctional blocking agent are preferably reacted together in the absence of solvents, in a sequence of addition of the reactants and considering the reaction conditions as mentioned above. For example, the diisocyanate may be reacted initially with blocking agent and then with the diol(s) of the diol component or initially with the diol(s) of the diol component and then with blocking agent. However, the diol component may, for example, also be divided into two or more portions, for example, also into the individual diols, for example, such that the diisocyanate is reacted initially with part of the diol component before further reaction with blocking agent and finally with the remaining proportion of the diol component. The individual reactants may in each case be added in their entirety or in two or more portions.

Once the reaction carried out in the absence of solvent is complete and the reaction mixture has cooled, solid polyurethanes with two blocked isocyanate groups per molecule are obtained. When low molar mass diols defined by empirical and structural formula are used for synthesis of the polyurethanes with two blocked isocyanate groups per molecule their molar masses calculated with the example of butanone oxime as the only blocking agent used are in the range of 572 or above, for example, up to 2000.

The resulted polyurethanes with two blocked isocyanate groups per molecule may be used directly as blocked isocyanate-functional polyurethane resins (A).

In a second preferred variant of the third embodiment, the polyurethane resins A have two blocked isocyanate groups per molecule and can be prepared by reacting stoichiometrically a diisocyanate component, bisphenol A or a diol component and at least one monofunctional blocking agent in the molar ratio x:(x−1):2, wherein x means any desired value from 2 to 6, preferably, from 2 to 4. With regard to the nature and use of the diisocyanate and diol component reference is made to the statements made in relation to the second preferred variant of the first embodiment.

With regard to the nature of the diisocyanate component, the nature and the use of the diol component and to the diols possible as constituents, in order to avoid repetition, reference is made to the statements made in relation to the second preferred variant of the first embodiment.

Preferably, only one monofunctional blocking agent is used. Examples of the at least one monofunctional blocking agent are the same as those listed above as examples in relation to the first preferred variant of the third embodiment.

The diisocyanate component, the bisphenol A or the diol component and the at least one monofunctional blocking agent are preferably reacted together in the absence of solvents, in a sequence of addition of the reactants and considering the reaction conditions as mentioned above. For example, the diisocyanates of the diisocyanate component may be reacted initially with blocking agent and then with the bisphenol A or with the diol(s) of the diol component or initially with the bisphenol A or with the diol component and then with blocking agent. However, the bisphenol A or the diol component may, for example, also be divided into two or more portions, for example, also into the individual diols, for example, such that the diisocyanate component is reacted initially with part of the bisphenol A or of the diol component before further reaction with blocking agent and finally with the remaining proportion of the bisphenol A or of the diol component. In a very similar manner, however, the diisocyanate component may, for example, also be divided into two or more portions, for example, also into the individual diisocyanates, for example, such that the bisphenol A or the diol component and blocking agent are reacted initially with part of the diisocyanate component and finally with the remaining proportion of the diisocyanate component. The individual reactants may in each case be added in their entirety or in two or more portions.

Once the reaction carried out in the absence of solvent is complete and the reaction mixture has cooled, solid polyurethanes with two blocked isocyanate groups per molecule are obtained. When low molar mass diols defined by empirical and structural formula are used for synthesis of the polyurethanes with two blocked isocyanate groups per molecule, their molar masses calculated with the example of butanone oxime as the only blocking agent used are in the range of 570 or above, for example, up to 2000.

The resulted polyurethanes with two blocked isocyanate groups per molecule may be used directly as blocked isocyanate-functional polyurethane resins (A).

In a third preferred variant of the third embodiment, the polyurethane resins (A) are polyurethanes with blocked isocyanate groups and can be prepared by reacting stoichiometrically a trimer of a (cyclo)aliphatic diisocyanate, 1,6-hexane diisocyanate, bisphenol A or a diol component and at least one monofunctional blocking agent in the molar ratio 1:x:x:3, wherein x means any desired value from 1 to 6, preferably, from 1 to 3. With regard to the nature and use of the diol component and to the diols possible as constituents reference is made to the statements made in relation to the third preferred variant of the second embodiment.

With regard to the nature of the trimer of the (cyclo)aliphatic diisocyanate, the nature and the use of the diol component and to the diols possible as constituents, in order to avoid repetition, reference is made to the statements made in relation to the third preferred variant of the second embodiment.

Preferably, only one monofunctional blocking agent is used. Examples of the at least one monofunctional blocking agent are the same as those listed above as examples in relation to the first preferred variant of the third embodiment.

The trimer of the (cyclo)aliphatic diisocyanate, the 1,6-hexane diisocyanate, the bisphenol A or the diol component and the at least one monofunctional blocking agent are preferably reacted together in the absence of solvents. The reactants may here all be reacted together simultaneously or in two or more synthesis stages. Synthesis procedures in which the blocking agent or the bisphenol A or the diol component and the trimer of the (cyclo)aliphatic diisocyanate alone are reacted with one another are preferably avoided.

When the synthesis is performed in multiple stages, the reactants may be added in the most varied order, for example, also in succession or in alternating manner. For example, the 1,6-hexane diisocyanate may be reacted initially with a mixture of the bisphenol A or of the diol component and the blocking agent and then with the trimer of the (cyclo)aliphatic diisocyanate or a mixture of the isocyanate-functional components with the bisphenol A or the diol component and the blocking agent or a mixture of the isocyanate-functional components may be reacted initially with blocking agent and then with the bisphenol A or the diol component. In the case of a diol combination, the diol component may, for example, also be divided into two or more portions, for example, also into the individual dihydroxy compounds. The individual reactants may in each case be added in their entirety or in two or more portions. The reaction is exothermic and proceeds at a temperature above the melting temperature of the reaction mixture. The reaction temperature is, for example, 60 to 200° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvents is complete and the reaction mixture has cooled, solid polyurethanes with blocked isocyanate groups and with number average molar masses in the range of 1,500 to 4,000 are obtained. The resulted polyurethanes with blocked isocyanate groups may be used directly as blocked isocyanate-functional polyurethane resins (A).

If, during the preparation of polyurethane resins (A) according to the third embodiment, monoalcohols with one or more, in particular one tertiary amino group, such as, for example, N,N-dimethylethanol amine, N,N-dimethylisopropanol amine or N,N-dimethyl-2-(2aminoethoxy)ethanol are used instead of the monofunctional blocking agents, polyurethane resins with tertiary amino groups usable as resins (A) in AED coating compositions are obtained.

The at least one resin (A) is present in particulate form, in particular, in the form of particles with a non-spherical shape, in the AED coating compositions, in particular within the generally aqueously dispersed AED binder (B). The average particle size (mean particle diameter) of the (A) particles determined by means of laser diffraction is, for example, 1 to 100 μm. The (A) particles may be formed by grinding (milling) of the solid resin (A). For example, conventional powder coat production technology may be used for that purpose. The (A) particles may either be stirred or mixed as a ground powder into the AED binder (B) not yet converted into the aqueous phase or into a non-aqueous paste resin, wherein it is possible subsequently to perform additional wet grinding or dispersing of the (A) particles, for example, by means of a bead mill, in the resultant suspension.

A further method for forming the (A) particles involves hot dissolution of the at least one resin (A) in a dissolution medium and subsequent particle formation during and/or after cooling. Dissolution of the at least one resin (A) may be performed in particular in a proportion or the entirety of the AED binder (B) with heating, for example, to the melting temperature or above, for example, to temperatures of 40 to above 200° C., whereupon the (A) particles may form during and/or after the subsequent cooling. The AED binder (B) used as dissolution medium for the at least one resin (A) may here be present liquid as such or as a solution in an organic solvent (mixture). Thorough mixing or stirring is preferably performed during cooling. Dissolution of the at least one resin (A) may also be performed with heating in an organic solvent (mixture), wherein the formation of the (A) particles, which proceeds during and/or after the subsequent cooling, may proceed in the solvent itself. It is also possible to allow the formation of the (A) particles after mixing of the resultant, as yet uncooled solution with the AED binder (B). By using the method of hot dissolution and subsequent (A) particle formation during and/or after cooling, it is in particular possible to produce particles with average particle sizes at the lower end of the range of average particle sizes, for example, in the range of 1 to 50 μm, in particular 1 to 30 μm.

In addition to the resin solids content, water and the content of the at least one resin (A) that is essential for the invention, the AED coating compositions may contain pigments, fillers, solvents and/or coating additives.

Examples of pigments are the conventional inorganic and/or organic colored pigments and/or special effect pigments, such as, titanium dioxide, iron oxide pigments, carbon black, phthalocyanine pigments, quinacridone pigments, metal pigments, such as, for example, titanium, aluminium or copper pigments, interference pigments, such as, for example, titanium dioxide-coated aluminium, coated mica, platelet-like iron oxide, platelet-like copper phthalocyanine pigments. Examples of fillers are kaolin, talcum or silicon dioxide. Also, anti-corrosive pigments may be used, such as, for example, zinc phosphate or organic corrosion inhibitors. The type and quantity of the pigments depends on the proposed application of the AED coating agents. If clear coatings are to be obtained, then no or only transparent pigments, such as, for example, micronized titanium dioxide or silicon dioxide are used. If opaque coatings are to be obtained, the AED coating composition preferably contains coloring pigments.

The pigments and/or fillers may be dispersed in a portion of the non-aqueous AED binder and then ground in suitable equipment, for example, a pearl mill, after which completion takes place by mixing with the remaining proportion of AED binder. After addition of neutralizing agent—if this has not already taken place—the AED coating composition or bath may then be produced from this material by dilution with water (one-component method).

Pigmented AED coating compositions or baths may also be prepared by mixing a AED binder dispersion and a separately prepared pigment paste (two-component method). For example, an AED binder dispersion is diluted further with water and an aqueous pigment paste is then added. Aqueous pigment pastes are prepared by methods known to the skilled person, preferably by dispersing the pigments and/or fillers in paste resins conventionally used for these purposes and known to the skilled person. Examples of paste resins which can be used in AED coating compositions are described, for example, in EP-A-0 183 025 and EP-A-0 469 497.

The pigment plus filler/resin solids weight ratio of the AED coating compositions is, for example, 0:1 to 0.8:1; for pigmented AED coating compositions it is preferably from 0.05:1 to 0.4:1.

The AED coating compositions may contain additives conventional in coatings, for example, in quantity proportions from 0.1 wt. % to 5 wt. %, based on the resin solids. These are, for example, wetting agents, neutralizing agents, leveling agents, catalysts, corrosion inhibitors, antifoaming agents, light stabilizers, antioxidants and anti-cratering additives. The additives may be introduced in any manner, for example, during binder synthesis, during the preparation of the AED binder dispersions, by way of a pigment paste, or separately.

The AED coating compositions may contain conventional solvents in conventional proportions of, for example, 0 to 5 wt %, based on the AED coating bath ready for coating. Examples of such solvents include glycol ethers, such as, butyl glycol and ethoxy propanol, and alcohols, such as, butanol. The solvents may be introduced in any manner, for example, as a constituent of AED binder or cross-linker solutions, by way of a AED binder dispersion, as a constituent of a pigment paste or by separate addition.

As mentioned above, the AED coating compositions may be prepared by the known methods for the preparation of AED coating baths, i.e., in principle both by means of the one-component and by means of the two-component method described above.

During the preparation of the AED coating compositions by the one-component method, it is possible, for example, to operate in such a way that the at least one resin (A) is present in the presence of non-aqueous constituents of the AED coating composition, in particular, in the presence of the non-aqueous AED binder (B) and is converted with these to the aqueous phase by dilution with water as known by a person skilled in the art.

During the preparation of the AED coating compositions by the two-component method, it is also possible to operate in such a way that the at least one resin (A) is present in the presence of the non-aqueous AED binder (B) and is converted together with these to the aqueous phase—after the addition of neutralizing agent, unless this has already been done—by dilution with water. An AED binder dispersion containing the at least one resin (A) is thus obtained. A pigmented AED coating composition or bath may then be prepared from the AED binder dispersion thus obtained by mixing with a separate pigment paste. Alternatively, if the two-component method is used, it is also possible to operate in such a way that an aqueous pigment paste containing the at least one resin A is added to an AED binder dispersion. The latter paste may be prepared, for example, by preparation of a non-aqueous paste resin containing the at least one resin (A), conversion into an aqueous paste resin and dispersing of pigments and/or fillers in its presence.

The at least one resin (A) may also be added separately to the AED coating compositions, for example, as a corrective additive. For example, it is also possible to carry out the separate addition afterwards to AED coating baths ready for coating. The at least one resin (A) may be used as an organic or aqueous preparation. The at least one resin (A) may, for example, be a constituent of a non-aqueous, but already neutralized paste resin and be added this way to the AED coating bath. However, the at least one resin (A) may also initially be converted into a water-thinnable form; for example, the separate, in particular, subsequent addition may happen as a constituent of an aqueous pigment paste, or the at least one resin A may be added as a constituent of a AED binder dispersion or in an aqueous paste resin.

The AED coating compositions according to the invention are particularly suitable for coating work pieces with an electrically conductive surface, e.g., metal, electrically conductive (e.g., metallised) plastic, electrically conductive wood or electrically conductive coatings (e.g., lacquers), for example, for priming and/or one-coat lacquering of household and electrical appliances, steel furniture, structural members and accessories for agricultural machinery and cars as well as car bodies, particularly for clear lacquer coating of aluminium, such as, e.g., pre-treated aluminium profiles, and for sealing conductive coats (e.g., electrodeposition lacquer coats).

The AED primer or one coating layer may optionally be provided with further coating layers. The AED coating compositions according to the invention may, however, also be anodically deposited and baked, for example, as a top coat, a clear coat or as a coating layer which is arranged within a multilayer coating and may have a decorative function.

In a suitable coating line, the substrate to be coated is immersed in the electrodeposition bath filled with AED composition according to the invention and connected as an anode to a counterelectrode, which can also be formed by the coating vessel, in a d.c. circuit. Coating lines of this type are known to the person skilled in the art and are described, for example, in “Glasurithandbuch” 1984, pages 374-384.

AED coating layers may be deposited in the usual way from the AED coating compositions, for example, in a dry layer thickness of 10 to 30 μm, onto electrically conductive, for example, metallic substrates connected as the anode, and baked at object temperatures of, for example, 100 to 220° C., preferably, 100 to 190° C. and/or baked with the support of an IR radiator, and/or by exposure to high-energy radiation such as an electron beam, for example, UV radiation.

### EXAMPLES

### Examples 1a to 1d

### Preparation of Polyurethanes with Two Blocked Isocyanate Groups

Polyurethanes with two blocked isocyanate groups were produced by reacting 1,6-hexane diisocyanate with diols and butanone oxime in accordance with the following general synthesis method:

1,6-hexane diisocyanate (HDI) was initially introduced into a 2 litre four-necked flask equipped with a stirrer, thermometer and column and 0.01 wt. % dibutyltin dilaurate, relative to the initially introduced quantity of HDI, were added. The reaction mixture was heated to 60 ° C. Butanone oxime was then apportioned in such a manner that the temperature did not exceed 80° C. The reaction mixture was stirred at 80° C. until the theoretical NCO content had been reached. Once the theoretical NCO content had been reached, the diols A, B, C were added one after the other, in each case in a manner such that a temperature of 140° C. was not exceeded. In each case, the subsequent diol was not added until the theoretical NCO content had been reached. The reaction mixture was stirred at a maximum of 140° C. until no free isocyanate could be detected. The hot melt was then discharged and allowed to cool and solidify.

The resultant solid polyurethanes with two blocked isocyanates were in each case comminuted, ground and sieved by means of grinding and sieving methods conventional for the production of powder coatings and, in this manner, converted into binder powders with an average particle size of 20μm (determined by means of laser diffraction).

The melting behavior of the polyurethanes with two blocked isocyanate groups was investigated by means of DSC (differential scanning calorimetry, heating rate 10 K/min).

Examples 1a to 1d are shown in Table 1. The Table states which reactants were reacted together in what molar ratios and the final temperature of the melting process measured by DSC is stated in ° C.

TABLE 1

| | | Mols | | | | |
|---|---|---|---|---|---|---|
| | Mols | butanone | Mols | Mols | Mols | |
| Example | HDI | oxime | diol A | diol B | diol C | FT |
| 1a | 3 | 2 | 1 PROP | 1 HEX | | 125° C. |
| 1b | 3 | 2 | 2 PENT | | | 127° C. |
| 1c | 4 | 2 | 1 PENT | 1 PROP | 1 HEX | 113° C. |
| 1d | 3 | 2 | 1 PENT | 1 HEX | | 114° C. |

FT: Final temperature of the melting process
HEX: 1,6-hexanediol
PENT: 1,5-pentanediol
PROP: 1,3-propanediol

### Examples 2a to 2d

### Preparation of Polyurethanes With Blocked Isocyanate Groups

Polyurethanes with blocked isocyanate groups were produced by reacting t-HDI (trimeric hexanediisocyanate; Desmodur® N3600 from Bayer), HDI, a diol component and butanone oxime in accordance with the following general synthesis method:

A mixture of t-HDI and HDI was initially introduced into a 2 litre four-necked flask equipped with a stirrer, thermometer and column and 0.01% by weight dibutyl tin dilaurate, based on the quantity of isocyanate introduced, were added. The reaction mixture was heated to 60° C. A mixture of butanone oxime and diol(s) was then added such that 140° C. was not exceeded. The temperature was carefully increased to a maximum of 140° C. and the mixture stirred until no more free isocyanate could be detected. The hot melt was then discharged and allowed to cool and solidify.

The resultant solid polyurethanes with blocked isocyanate groups were in each case comminuted, ground and sieved by means of grinding and sieving methods conventional for the production of powder coatings and, in this manner, converted into binder powders with an average particle size of 20μm (determined by means of laser diffraction).

The melting behavior of the polyurethanes with blocked isocyanate groups was investigated by means of DSC (heating rate 10 K/min).

Examples 2a to 2d are shown in Table 2. The table states which reactants were reacted together and in which molar ratios and the final temperature of the melting process measured using DSC is indicated in ° C.

TABLE 2

| | | | Mols of | | | |
|---|---|---|---|---|---|---|
| | Mols of t- | Mols of | butanone | Mols of | Mols of | |
| Example | HDI | HDI | oxime | diol A | diol B | FT |
| 2a | 1 | 3 | 3 | 3 PROP | | 112° C. |
| 2b | 1 | 3 | 3 | 3 HEX | | 122° C. |
| 2c | 1 | 2 | 3 | 1 PROP | 1 HEX | 102° C. |
| 2d | 1 | 2 | 3 | 2 HEX | | 118° C. |

cf. Table 1 for abbreviations

### Examples 3a to 3f

### Preparation of Polyurethane Diols

Polyurethane diols were produced by reacting HDI (1,6-hexane diisocyanate) or a mixture of HDI and DCMDI (dicyclohexylmethane diisocyanate) with one or more diols in accordance with the following general synthesis method:

One diol or a mixture of diols was initially introduced into a 2 litre four-necked flask equipped with a stirrer, thermometer and column and 0.01 wt. % dibutyltin dilaurate, relative to the initially introduced quantity of diol(s), were added. The mixture was heated to 80° C. HDI or a HDI/DCMDI mixture was then apportioned and a temperature was maintained so that the hot reaction mixture did not solidify. The reaction mixture was stirred until no free isocyanate could be detected (NCO content <0.1%). The hot melt was then discharged and allowed to cool and solidify.

The resultant solid polyurethane diols were in each case comminuted, ground and sieved by means of grinding and sieving methods conventional for the production of powder coatings and, in this manner, converted into binder powders with an average particle size of 50 μm (determined by means of laser diffraction).

The melting behavior of the polyurethane diols was investigated by means of DSC (differential scanning calorimetry, heating rate 10 K/min).

Examples 3a to 3f are shown in Table 3. The Table states which reactants were reacted together in what molar ratios and the final temperature of the melting process measured by DSC is stated in ° C.

TABLE 3

| | Mols | Mols | Mols | Mols | Mols | |
|---|---|---|---|---|---|---|
| Example | HDI | DCMDI | diol A | diol B | diol C | FT |
| 3a | 2 | | 2 PROP | 1 HEX | | 131° C. |
| 3b | 2 | | 1 PROP | 2 HEX | | 150° C. |
| 3c | 2 | | 3 PENT | | | 137° C. |
| 3d | 3 | | 1.33 PENT | 1.33 | 1.33 | 118° C. |
| | | | PROP | | HEX | |
| 3e | 2 | | 1 BPA | 2 HEX | | 149° C. |
| 3f | 1.5 | 0.5 | 3 PENT | | | 126° C. |

cf. Table 1 for abbreviations

### Examples 4a to 4b

### Preparation of Polyurethane Polyols

Polyurethane polyols were produced by reacting HDI or a mixture of HDI and DCMDI with a mixture of GLY (glycerol) and a diol in accordance with the following general synthesis method:

The polyols were initially introduced into a 2 litre four-necked flask equipped with a stirrer, thermometer and column and 0.01 wt. % dibutyltin dilaurate, relative to the initially introduced quantity of polyols, were added. The mixture was heated to 80° C. HDI or a HDI/DCMDI mixture was then apportioned and a temperature was maintained so that the hot reaction mixture did not solidify. The reaction mixture was stirred until no free isocyanate could be detected (NCO content <0.1%). The hot melt was then discharged and allowed to cool and solidify.

The resultant solid polyurethane polyols were in each case comminuted, ground and sieved by means of grinding and sieving methods conventional for the production of powder coatings and, in this manner, converted into binder powders with an average particle size of 50 μm (determined by means of laser diffraction).

The melting behavior of the polyurethane polyols was investigated by means of DSC (differential scanning calorimetry, heating rate 10 K/min).

Examples 4a to 4b are shown in Table 4. The Table states which reactants were reacted together in what molar ratios and the final temperature of the melting process measured by DSC is stated in ° C.

TABLE 4

| | | Mols | | Mols | |
|---|---|---|---|---|---|
| Example | Mols HDI | DCMDI | Mols GLY | Diol A | FT |
| 4a | 2 | | 1 | 2 HEX | 130° C. |
| 4b | 1.5 | 0.5 | 1 | 2 HEX | 117° C. |

cf. Table 1 for abbreviations

### Example 5

### Production of a Blocked Polyisocyanate

2.75 mol of diphenylmethane diisocyanate and 233 g of methyl isobutyl ketone were weighed out into a reaction vessel and stirred at room temperature. Then 2.75 mol of diethylene glycol monobutyl ether were added in one hour with cooling. Once a constant NCO value had been reached, 1 mol of the 1:1 adduct obtained from propylene carbonate and diethanolamine and 4.1 g of dibutyltin dilaurate (catalyst) were added. The reaction mixture was kept at 50° C. until no free isocyanate could any longer be detected.

### Example 6a) to r)

### Production of AED Dispersion With Hardener Resin

a) A mixture of 1.80 parts by weight of diethanolamine and 3 parts by weight of fully deionised water is added at 100° C. to 57.00 parts by weight of a polyester resin with an acid number of 49 and a hydroxyl number of 60 (produced from 26.17 parts by weight of neopentyl glycol, 5.43 parts by weight of trimethylolpropane, 10.83 parts by weight of isophthalic acid, 21.45 parts by weight of isodecanol and 36.12 parts by weight of trimellitic anhydride) contained in a reaction vessel equipped with stirrer, thermometer and reflux condenser and stirred for 10 minutes to form a homogeneous mixture, following which 0.15 part by weight of a commercially available biocide is also stirred in for 10 minutes to form a homogeneous mixture. 38.05 parts by weight of fully deionised water are added while stirring. The mixture is stirred for 90 minutes at 80° C. and is then cooled rapidly to 25° C. 12.10 parts by weight of the commercially available melamine resin Cymel® 303 (Cytec) are added while stirring into 87.90 parts by weight of the polyester resin dispersion and then homogenized for 30 minutes.

b) to i) The polyurethane powders obtained in Examples 1a) to d) and 2a) to d) were in each case thoroughly mixed into the molten binder obtained under 6a) in a solids weight ratio of 10.0 parts of the respective powder:100 parts of AED binder.

k) to r) The polyurethane powders obtained in Examples 3a) to f and 4a) to b) were in each case thoroughly mixed into the molten binder obtained under 6a) in a solids weight ratio of 10.0 parts of the respective powder:100 parts of AED binder. Each mixture was heated to above the melting point of the respective polyurethane powder under stirring until a hot solution was obtained. Thereafter, the hot solution was allowed to cool to 80° C. under stirring. After further cooling to room temperature in each case a solution of the polyester resin containing the respective finely dispersed solid polyurethane was obtained. To obtain the emulsion proceed as described in Example 6a).

### Examples 7

### Production of an Aqueous Black Pigment Paste

To produce 100 kg of black pigment paste, 24.50 kg of 75% paste resin are placed in a dissolver and neutralized with 2.18 kf of a 50% diisopropanolamine solution, and then diluted with 40.90 kg of fully deionized water.

2.5 kg of a polybutylene, 2.21 kg of a channel carbon black, 2.21 kg of a furnace carbon black as well as 25.50 kg af aluminium hydrosilicate are then added in the specified order while stirring.

The grinding material thus obtained is stirred for 15 minutes at 40° C. After a swelling time of 12 hours the grinding material is dispersed in a Coball mill under specified conditions.

### Examples 8a) to r)

### Production of AED Bath and Testing

1467.20 g of fully deionised water are placed in a 2 litre capacity beaker. 5.00 g of 50% diisopropanolamine and 5.00 g of dimethylethanolamine are added in succession while stirring. 371.1 g of the dispersion produced in Example 6a) to r) including the hardener resin are added stepwise while stirring. After a homogenisation time of 10 minutes 151.70 g of the pigment paste produced in Example 7 are added slowly while stirring. After a homogenisation time of about 1 hour the electro-dipcoating bath is ready for coating.

Degreased, unphosphated steel test panels (Ra value=1.5 μm) were provided with a 20 μm thick AED coat from AED baths 8a) to r) (coating conditions: 2 minutes at 32° C. at a deposition voltage of 240 V; baking conditions: 20minutes, 160° C. object temperature). The roughness of the baked AED clear coat layers was measured as an Ra value (DIN 4777, using T500 Lommel-Tester, cut-off 2.5 mm, 4.8 mm measurement path).

Perforated (perforation diameter 10 mm), degreased, unphosphated steel test panels were also coated in an entirely similar manner and then exposed to salt spray conditions to DIN 50 021-SS for 144 hours. The edges of the perforations were evaluated for edge rusting (ratings KW 0 to 5: KW 0=no rust on edges; KW 1=isolated rust spots on edges; KW 2=rust spots on less than ⅓ of edges; KW 3=⅓ to ⅔ of edges covered with rust; KW 4=more than ⅔ of edges covered with rust; KW 5=edges completely rusty).

TABLE 5

| CED clear | | | Roughness |
|---|---|---|---|
| coat under | Polyurethane | Edge rusting, | (Ra (4.8 mm) value |
| test | used | rating | in μm) |
| 8a, Comparison | —/— | 4 | 0.56 |
| 8b | 1a | 2-3 | 0.54 |
| 8c | 1b | 2-3 | 0.53 |
| 8d | 1c | 3 | 0.52 |
| 8e | 1d | 4 | 0.55 |
| 8f | 2a | 3 | 0.54 |
| 8g | 2b | 3 | 0.54 |
| 8h | 2c | 4 | 0.55 |
| 8i | 2d | 3 | 0.54 |
| 8k | 3a | 2-3 | 0.53 |
| 8l | 3b | 2 | 0.52 |
| 8m | 3c | 2-3 | 0.53 |
| 8n | 3d | 3 | 0.53 |
| 8o | 3e | 2 | 0.52 |
| 8p | 3f | 4 | 0.55 |
| 8q | 4a | 2-3 | 0.53 |
| 8r | 4b | 3 | 0.55 |

What is claimed is:

1. AED coating composition comprising, apart from water,
(A) 1 to 20 wt %, relative to the resin solids content of the composition, of at least one resin with functional groups selected from the group consisting of hydroxyl groups, free isocyanate groups and blocked isocyanate groups, the resin is present as particles with melting temperatures from 40 to 200° C.,
(B) at least one film-forming, self- or externally cross-linking AED binder different from resin (A), and
(C) optionally, at least one component selected from the group consisting of cross-linking agents, paste resins, grinding resins, nonionic resins, pigments, fillers, extenders, coating additives and organic solvents.

2. The composition according to claim 1 comprising, apart from water,
(A) 5 to 15 wt %, relative to the resin solids content of the composition, of at least one resin with functional groups selected from the group consisting of hydroxyl groups, free isocyanate groups and blocked isocyanate groups, the resin is present as particles with melting temperatures from 40 to 200° C.,
(B) 50 to 90 wt % of at least one film-forming, self- or externally cross-linking AED binder different from resin (A), and
(C) at least one component selected from the group consisting of cross-linking agents, paste resins, grinding resins, nonionic resins, pigments, fillers, extenders, coating additives and organic solvents.

3. The composition according to claim 1 wherein the resin of component (A) is present as particles with melting temperatures from 60 to 180° C.

4. The composition according to claim 1 wherein the resin solids content comprising 50 to 100 wt % of AED binder (B), 0 to 40 wt % of cross-linkers, and 0 to 10 wt % of nonionic resins.

5. The composition according to claim 1 wherein the resin of component (A) is a polyurethane resin.

6. The composition according to claim 5 wherein the polyurethane resin is a hydroxyl-functional polyurethane resin having a hydroxyl value of 50 to 300 mg KOH/g.

7. The composition according to claim 5 wherein the polyurethane resin is an isocyanate-functional polyurethane resin having an isocyanate content of 2 to 13.4 wt % (calculated as NCO, molar mass 42).

8. The composition according to claim 5 wherein the polyurethane resin has blocked isocyanate groups having a latent isocyanate content in the range from 2 to 21.2 wt. %, calculated as NCO and relative to the corresponding underlying polyurethane resins.

9. The composition according to claim 1 wherein the resin of component (A) is present in particulate form wherein the particles have an average particle size of 1 to 100 μm.

10. A process for preparation the coating composition of claim 1 comprising the steps wherein the particles of component (A) are mixed as a ground powder into the AED binder (B).

11. A process for preparation the coating composition of claim 1 comprising the steps of hot dissolution of the resin of component (A) in the AED binder of component (B) and subsequently cooling.

12. A process for coating a substrate wherein the coating composition according to claim 1 is used.

13. The process according to claim 12 wherein the coating composition is used for priming and/or one-coat lacquering of household and electrical appliances, steel furniture, structural members, accessories for agricultural machinery, cars and car bodies.

14. The process according to claim 12 wherein the coating composition is used for clear lacquer coating of aluminium, pre-treated aluminium profiles, and for sealing conductive coats.

15. The process according to claim 12 wherein the coating composition is anodically deposited and baked as a top coat, a clear coat or as a coating layer which is arranged within a multilayer coating.

16. A substrate coated with the AED coating composition of claim 1.
